(19) United States
(12) Patent Application Publication
(10) Pub. No.: US 2018/0324229 A1
(43) Pub. Date: Nov. 8, 2018

(54) SYSTEMS AND METHODS FOR PROVIDING EXPERT ASSISTANCE FROM A REMOTE EXPERT TO A USER OPERATING AN AUGMENTED REALITY DEVICE

(71) Applicant: Tsunami VR, Inc., Del Mar, CA (US)

(72) Inventors: David ROSS, San Diego, CA (US); Beth BREWER, Escondido, CA (US); Anthony DUCA, Carlsbad, CA (US); Morgan Nicholas GEBBIE, Carlsbad, CA (US)

(21) Appl. No.: 15/970,822

(22) Filed: May 3, 2018

Related U.S. Application Data
(60) Provisional application No. 62/501,744, filed on May 5, 2017.
(60) Provisional application No. 62/554,580, filed on Sep. 6, 2017.

(51) Int. Cl. H04L 29/06; G06F 3/14; G02B 27/01; G06T 19/00

(52) U.S. Cl. CPC H04L 65/4015; H04L 65/4069; G06T 19/006; G02B 27/017; G06F 3/1454

(57) ABSTRACT

Providing expert assistance from a remote expert to a user operating an augmented reality device. Particular systems and methods receive, at a server, a remote assistance request from a first user device operated by a first user located at a first location, and establish a network connection between the first user device and a second user device operated by a second user located at a second location in response to the remote assistance request. Visual information captured by a camera of the first user device is provided to the second user device operated by the second user. Assistance content generated by the second user using the second user device is provided to the first user device for presentation of the assistance content to the first user.

### RELATED APPLICATIONS

This application relates to the following related application(s): U.S. Pat. Appl. No. 62/501,744, filed May 5, 2017, entitled METHOD AND APPARATUS FOR PROVIDING REMOTE ASSISTANCE VIA VIRTUAL AND AUGMENTED REALITY; and U.S. Pat. Appl. No. 62/554,580, filed Sep. 6, 2017, entitled METHOD AND SYSTEM FOR PROVIDING REMOTE ASSISTANCE VIA A RECORDING OF A VIRTUAL SESSION. The content of each of the related application(s) is hereby incorporated by reference herein in its entirety.

### TECHNICAL FIELD

This disclosure relates to virtual training, collaboration or other virtual technologies.

### BRIEF DESCRIPTION OF THE DRAWINGS

FIG. 1A and FIG. 1B depict aspects of a system on which different embodiments are implemented for providing expert assistance from a remote expert to a user operating an augmented reality device.

FIG. 2 depicts a method for providing expert assistance from a remote expert to a user operating an augmented reality device.

FIG. 3A and FIG. 3B illustrate different implementations of a method for providing expert assistance from a remote expert to a user operating an augmented reality device.

FIG. 4 illustrates the See What I See and Do What I Do remote assistance.

FIG. 5 is a block diagram of system for providing remote assistance via AR, VR or MR.

FIG. 6 and FIG. 7 are block diagrams of methods for providing remote assistance.

### DETAILED DESCRIPTION

This disclosure relates to different approaches for providing expert assistance from a remote expert to a user operating an augmented reality device.

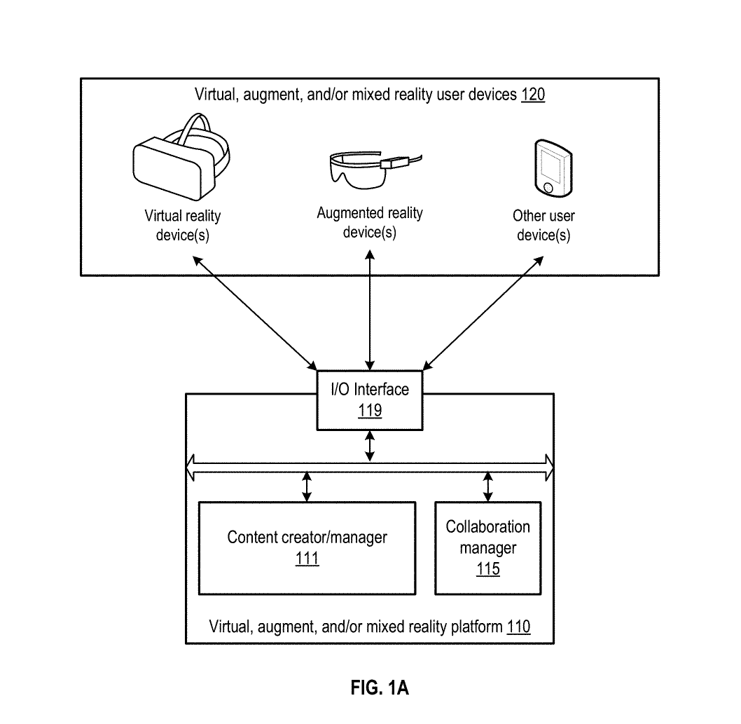

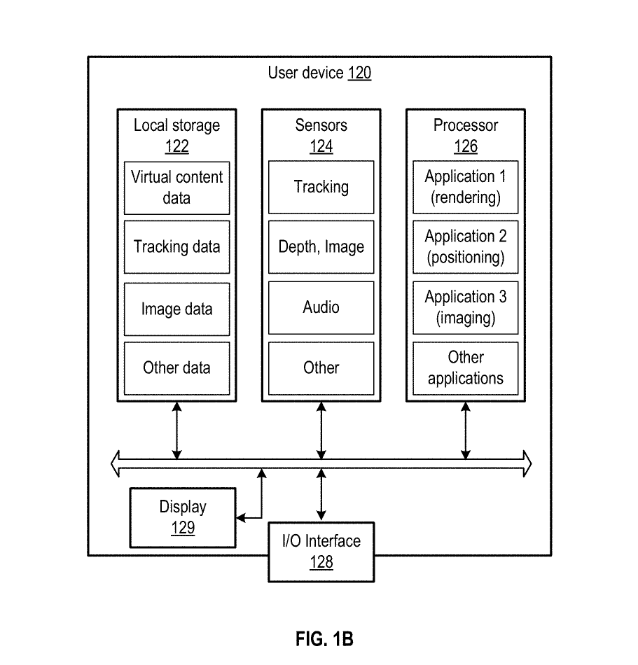

FIG. 1A and FIG. 1B depict aspects of a system on which different embodiments are implemented for providing expert assistance from a remote expert to a user operating an augmented reality device. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for providing expert assistance from a remote expert to a user operating an augmented reality device are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for providing expert assistance from a remote expert to a user operating an augmented reality device.

### Providing Expert Assistance from a Remote Expert to a User Operating an Augmented Reality Device

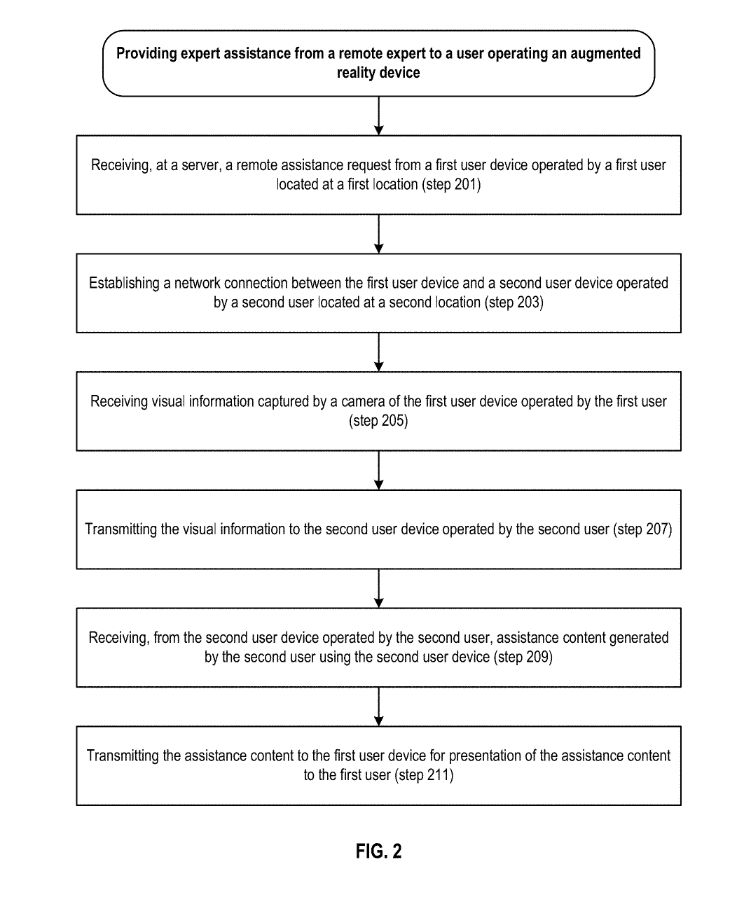

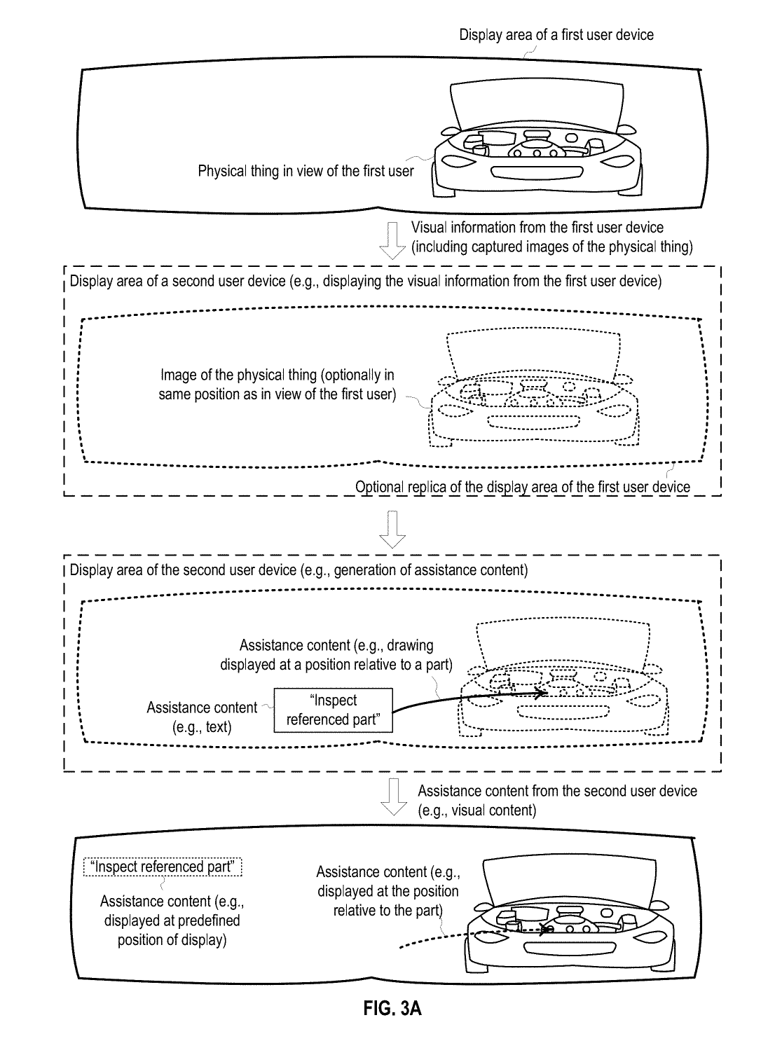

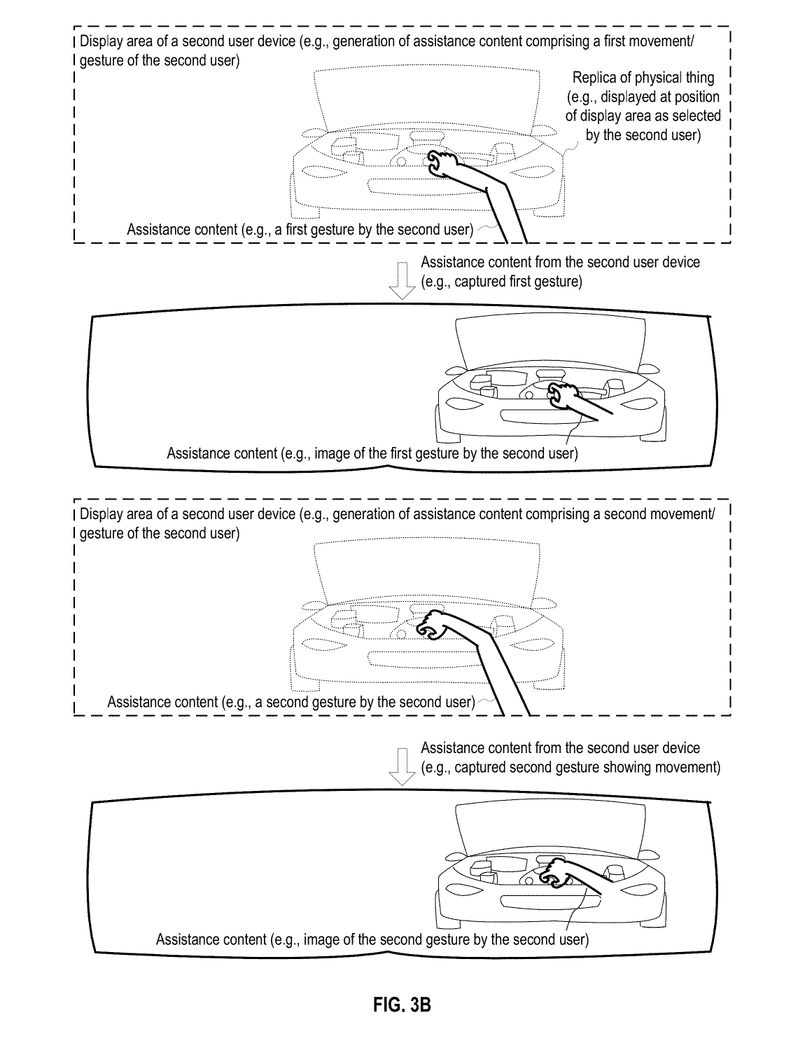

FIG. 2 depicts a method for providing expert assistance from a remote expert to a user operating an augmented reality device. The method comprises: receiving, at a server, a remote assistance request from a first user device operated by a first user located at a first location (step 201); after receiving the remote assistance request, establishing a network connection between the first user device and a second user device operated by a second user located at a second location (step 203); receiving visual information captured by a camera of the first user device operated by the first user, wherein the visual information includes an image of a physical object in view of the first user (step 205); transmitting the visual information to the second user device operated by the second user (step 207); receiving, from the second user device operated by the second user, assistance content generated by the second user using the second user device (step 209); and transmitting the assistance content to the first user device for presentation of the assistance content to the first user (step 211).

By way of example, the established network connection may be through the server.

An example of receiving visual information includes streaming images captured by the camera to the server from the first user device.

In one embodiment of the method depicted in FIG. 2, the first user device is a head-mounted augmented reality user device with a display that is at least partially transparent.

In one embodiment of the method depicted in FIG. 2, the second user device is a head-mounted augmented reality user device with a display that is at least partially transparent, or a head-mounted virtual reality device, stationary computer, or mobile computer with a non-transparent display.

In one embodiment of the method depicted in FIG. 2, the first user device is a head-mounted augmented reality user device with a display that is at least partially transparent, and the second user device is a head-mounted augmented reality user device with a display that is at least partially transparent.

In one embodiment of the method depicted in FIG. 2, the method further comprises: presenting the visual information on a display of the second user device.

In one embodiment of the method depicted in FIG. 2, the presented visual information includes the image of the physical object that is in view of the first user, the assistance content is generated for display at one or more positions relative to particular parts of the physical object, and the method further comprises: presenting the assistance content on a display of the first user device to appear at the one or more positions relative to the particular parts of the physical object.

In one embodiment of the method depicted in FIG. 2, the method comprises: presenting the assistance content at predefined locations of a display of the first user device. Examples of predefined locations include areas of the display that do not block the first user's view of the physical object.

In one embodiment of the method depicted in FIG. 2, the assistance content includes visual content or audio content generated by the second user.

Examples of visual content generated by the second user include: text, image(s), drawing(s), graphic(s), or other visual content created by the second user via any known user interface of the second user device; or text, image(s), drawing(s), graphic(s), a virtual object corresponding to the physical object, or other visual content selected from storage by the second user via any known user interface of the second user device.

Examples of audio content include: the second user's voice as captured by a microphone of the second user device; or a recording selected by the second user.

In one embodiment of the method depicted in FIG. 2, the assistance content includes instructions the first user must follow to complete a task in relation to the physical object.

In one embodiment of the method depicted in FIG. 2, the assistance content includes visual content generated by the second user, and the method further comprises: presenting the visual content on a display of the first user device.

In one embodiment of the method depicted in FIG. 2, the assistance content includes audio content, and the method further comprises: presenting the audio content using a speaker of the first user device.

In one embodiment of the method depicted in FIG. 2, the assistance content generated by the second user includes one or more movements or gestures the first user must make to complete a task in relation to the physical object in view of the first user, and the method further comprises: presenting a visual representation of the one or more movements or gestures on a display of the first user device.

In one embodiment of the method depicted in FIG. 2, the one or more movements or gestures generated by the second user are captured using a camera of the second user device.

In one embodiment of the method depicted in FIG. 2, visual representations of the one or more movements or gestures are presented on a display of the first user device as virtual hands that perform the movements and gestures.

In one embodiment of the method depicted in FIG. 2, the one or more movements or gestures are captured using an inertial sensor of the second user device or a peripheral device that is connect to the second user device and controlled by the second user.

Examples of inertial sensors include: an accelerometer; a gyroscope, or other inertial sensors. Examples of peripheral devices include gloves, controllers or any other suitable peripheral device.

In one embodiment of the method depicted in FIG. 2, the method further comprises: identifying the physical object; selecting assistance information about the identified physical object; and transmitting the assistance information to the first user device for presentation of the assistance information to the first user.

In one embodiment of the method depicted in FIG. 2, the first location and the second location are different.

An additional method for providing expert assistance from a remote expert to a user operating an augmented reality device comprises: (i) receiving, at a server, a remote assistance request from a first user device operated by a first user located at a first location, wherein the remote assistance request specifies an issue the first user has encountered with a physical object in view of the first user; (ii) optionally, receiving visual information captured by a camera of the first user device operated by the first user; (iii) providing a second user device operated by a second user located at a second location with a virtual object that is a virtual representation of a physical object in view of the first user; (iv) receiving, from the second user device, assistance content generated by the second user, wherein the assistance content instructs the first user how to resolve the issue the first user has encountered with the physical object; and (v) transmitting the assistance content to the first user device for presentation of the assistance content to the first user.

By way of example, the issue encountered with the physical object may be any of: a repair task, maintenance operation, or troubleshooting needed to be performed on the physical object (e.g., equipment), or a medical procedure needed to be performed on the physical object (e.g., human body).

By way of example, before providing the virtual object to the second user device, the virtual object is either (i) retrieved from storage (e.g., based on identifying information received from the first user or determined from the optional visual information using any technique known in the art), or (ii) generated (e.g., using known techniques of image analyses with respect to the visual information captured by the camera of the first user device).

By way of example, the assistance content may include instructions the first user must follow to complete a task in relation to the physical object (e.g., one or more manipulations of parts of the physical object the first user must make to resolve the issue).

In one embodiment of the additional method, the visual information includes an image of the physical object in view of the first user.

In one embodiment of the additional method, the second user device displays the virtual object to the second user.

In one embodiment of the additional method, the first user device is a head-mounted augmented reality user device with a display that is at least partially transparent, and wherein the second user device is a head-mounted augmented reality user device with a display that is at least partially transparent, or a head-mounted virtual reality device, stationary computer, or mobile computer with a non-transparent display.

In one embodiment of the additional method, the method further comprises: presenting the visual information on a display of the second user device, and presenting the assistance content to the first user via the first user device.

In one embodiment, the assistance content includes different types of content that is presented to the first user via the first user device (e.g., using the techniques that are described elsewhere herein). Examples of different types of content include: (i) visual or audio content generated by the second user as described elsewhere herein; (ii) one or more movements or gestures made by the second user in relation to a particular part of the virtual object that are presented to the first user relative to a respective part of the physical object that corresponds to that particular part of the virtual object; (iii) a movement of a particular part of the virtual object that is presented to the first user so the first user can replicate the movement relative to a part of the physical object that corresponds to the particular part of the virtual object; or (iv) other content.

By way of example, one or more movements or gestures of the second user can be captured using a camera of the second user device (e.g., an AR device), or sensed by sensors of a peripheral device operated by the second user (e.g., a glove, a controller or other peripheral device communicatively coupled to an AR, VR or MR device). Examples of sensors include inertial sensors, mechanical inputs, or other types of sensors. Such gestures or movements can be correlated to particular parts of the virtual object using known or other techniques. In one embodiment, virtual representations of the gestures or movements are depicted on a display of the first user device relative to parts of the physical object that are represented by the particular parts of the virtual object. In one embodiment, visual representations of the one or more movements or gestures are presented on a display of the first user device as virtual hands that perform the movements and gestures relative to parts of the physical object.

By way of example, movements of a particular part of the virtual object can be captured using a camera of the second user device (e.g., an AR device) that uses known or other techniques to track selection and movement of the particular part by the second user, or sensed using a peripheral device operated by the second user (e.g., a glove, a controller or other peripheral device communicatively coupled to an AR, VR or MR device) that uses known or other techniques to track selection and movement of the particular part by the second user. In one embodiment, a virtual representation of the movement is depicted on a display of the first user device. Depiction of the virtual representation can be on any portion of the display or at positions on the display relative to a part of the physical object that is represented by the particular part of the virtual object. For example, semi-transparent or opaque image(s) of the movement of the particular part of the virtual object may be presented to the user to appear to overlay the part of the physical object that is represented by the particular part of the virtual object. Alternatively, a video of the movement may be displayed on the display.

Also contemplated is a system for providing expert assistance from a remote expert to a user operating an augmented reality device, wherein the system comprises one or more machines and one or more non-transitory machine-readable media storing instructions that are operable, when executed by the one or more machines, to cause the one or more machines to perform operations of any of the methods described herein.

Also contemplated are one or more non-transitory machine-readable media embodying program instructions that, when executed by one or more machines, cause the one or more machines to implement any of the methods described herein.

### First Set of Additional Embodiments

Currently service agents out in the field rely on prior knowledge, any resources they can locate via an internet connection, and voice calls into next level support. In some cases service agents may not be able to remedy the problem without further education and/or hands on assistance from an expert which results in longer resolution times. By using the capabilities of augmented and virtual reality we can offer a solution that allows a service agent to receive remote assistance from an expert that can not only join the service agent in the agent's environment but also show the agent how to resolve the issue or perform the function.

Embodiments described herein may be used to enable a remote expert to assist a field technician with a resolution to a problem and/or on premise training. The remote expert can provide verbal instruction along with hand gestures to illustrate the procedure. The remote expert can oversee the field technician performance to ensure the problem has been remedied correctly. This eliminates the need for the remote expert to be called out to the location and reduces the length of time it takes to solve a problem.

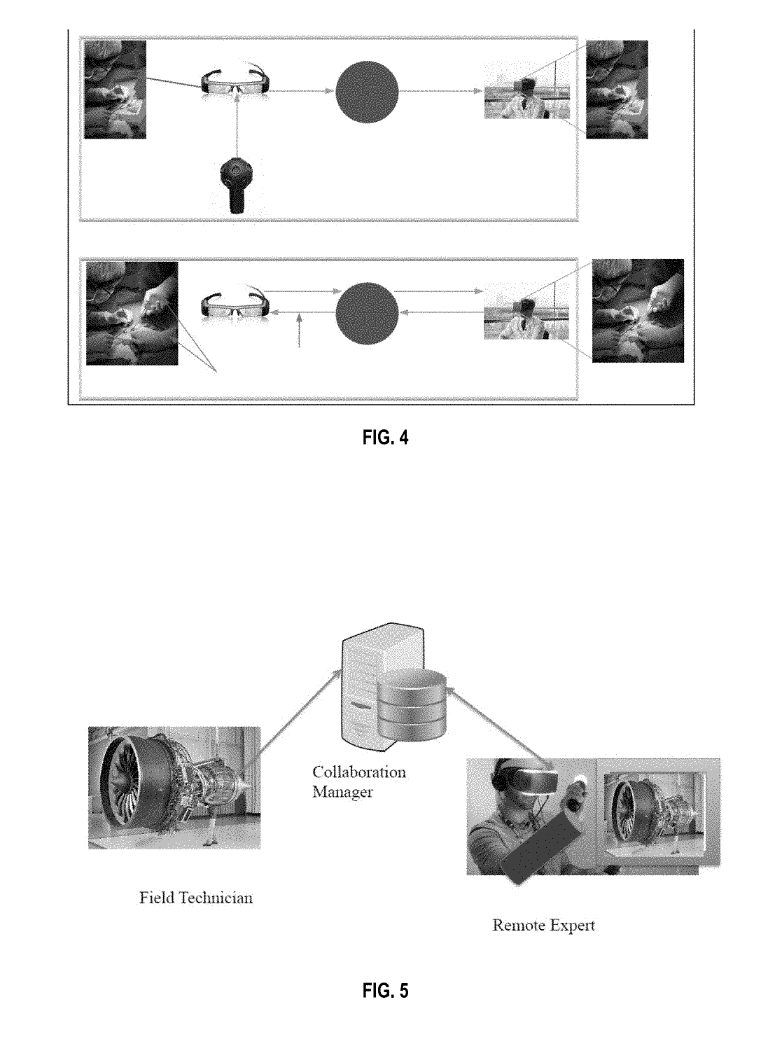

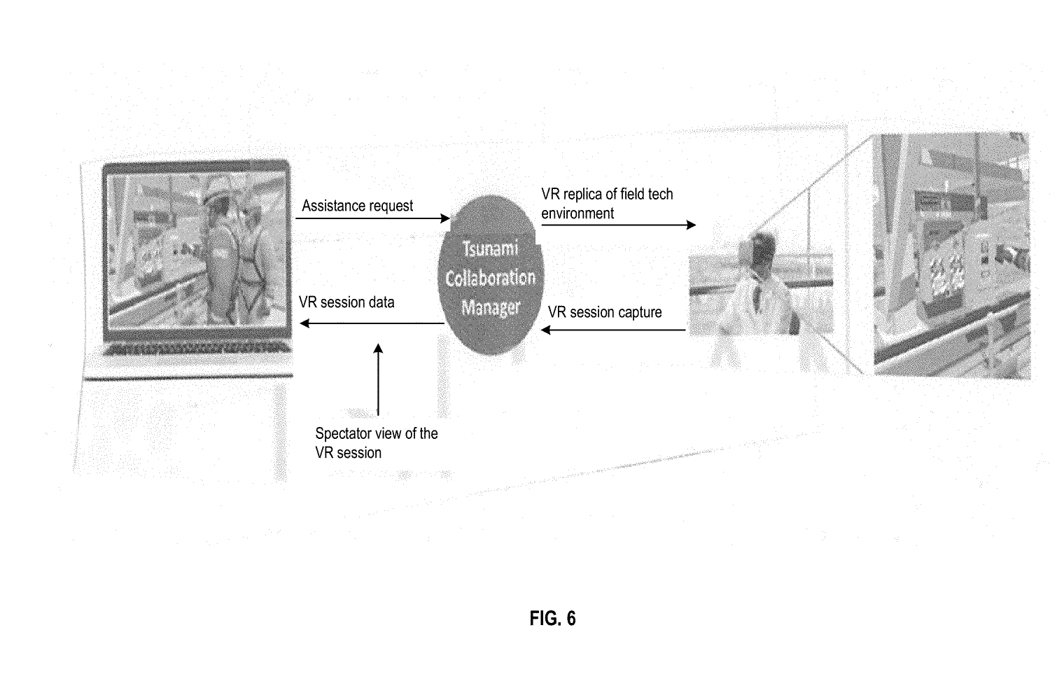

FIG. 4 illustrates the See What I See and Do What I Do remote assistance described below. FIG. 5 is a block diagram of a system for providing remote assistance via AR, VR or MR, as described below.

Embodiments below relate to systems and methods for providing remote assistance via augmented reality (AR), virtual reality (VR) or mixed virtual and augmented reality (MR).

One method comprises: receiving a remote assistance request at a collaboration manager on a server. The remote assistance request transmitted from an application of a display device at a remote location. The remote assistance request is to resolve a problem. The method also includes transmitting a remote expert request from the collaboration manager to an application on a remote expert device located at a remote expert site. The method also includes streaming content from the display device to the collaboration manager, and transmitting the content to an application on a remote expert device. The method also includes transmitting expert assistance content related to the streamed content from the application on the remote expert device to the application on the display device via the collaboration manager. The method also includes displaying the expert assistance content on the display device. By way of example, the display device may be an AR, VR or MR device.

Another method comprises: establishing a connection between an application on display and a collaboration manager on a server, the display device comprising a video camera and an display; authenticating the display device; transmitting a remote assistance request from the application on the display device to the collaboration manager, the remote assistance request to resolve a problem, the remote assistance request for a remote expert device; receiving a request from the collaboration manager at the display device to capture video using the video camera of the display device; streaming video from the video camera of the display device to the collaboration manager for transmission to the remote expert device; receiving an expert assistance content related to the video from the application on the remote expert device at the application on the display device; and displaying the expert assistance content on the display of the display device. By way of example, the display device may be an AR, VR or MR device.

Yet another method comprises: establishing a connection between a collaboration manager on a server and an application on an AR, VR or MR headset; authenticating the headset at the collaboration manager; receiving a remote assistance request at the collaboration manager, the remote assistance request transmitted from the headset at a remote location, the remote assistance request to resolve a problem, the headset comprising a video camera and an AR, VR, or MR display; transmitting a remote expert request from the collaboration manager to a remote expert device located at a remote expert site; establishing a connection between the collaboration manager and an application on remote expert device; transmitting a request from the collaboration manager to the headset to capture video using the video camera of the headset; streaming video from the video camera of the headset to the collaboration manager; transmitting the video to the application on the remote expert device; receiving an expert assistance content related to the video from the application on the remote expert device at the collaboration manager; transmitting the expert assistance content from the collaboration manager to the application on the headset; and displaying the expert assistance content on the display of the headset.

One system comprises a collaboration manager at a server, a display device comprising an application, and a remote expert device comprising an application. The collaboration manager is configured to establish a connection between the collaboration manager and the application on the display device. The collaboration manager is configured to receive a remote assistance request from the display device at a remote location, the remote assistance request to resolve a problem. The collaboration manager is configured to transmit a remote expert request to the remote expert device. The collaboration manager is configured to receive request content from the display device and transmit the request content to the application on the remote expert device. The collaboration manager is configured to receive an expert assistance content from the application on the remote expert device and then transmit the expert assistance content to the application on the display device. The expert assistance content is displayed on the display device. The request content utilizes at least one of AR, VR or MR.

Another system comprises: a collaboration manager at a server; an AR, VR, or MR headset comprising an application, a video camera and an AR, VR, or MR display; a remote expert device comprising an application. During operation of the system, (i) a connection is established between the collaboration manager and the application on the headset, and the headset is authenticated, (ii) a remote assistance request is transmitted from the headset at a remote location to the collaboration manager, the remote assistance request to resolve a problem, (iii) the remote expert request is transmitted from the collaboration manager to the remote expert device, (iv) video is streamed from the video camera of the headset to the collaboration manager and transmitted to the application on the remote expert device, (v) an expert assistance content related to the video is transmitted from the application on the remote expert device to the collaboration manager and then transmitted to the application on the headset, and (vi) the expert assistance content is displayed on the display of the headset.

In one embodiment of any of the above methods and systems, the expert assistance content is a plurality of movements and gestures to resolve the problem captured using at least one of an accelerometer or gyroscope of the remote expert device.

In one embodiment of any of the above methods and systems, the problem is an equipment repair. In one embodiment of any of the above methods and systems, the problem is a medical emergency.

In one embodiment of any of the above methods and systems, the remote expert device is selected from the group comprising a desktop computer, a laptop computer, a mobile phone, an AR headset, and a VR headset.

In one embodiment of any of the above methods and systems, the video is 360 degree video or 180 degree video.

In one embodiment of any of the above methods and systems, further steps and operation include displaying the video on a display endpoint of the remote expert device.

In one embodiment of any of the above methods and systems, further steps and operation include rendering the expert assistance content on the application of the headset into a plurality of movements performed by virtual hands displayed on the display of the headset. The plurality of movements may later be mimicked (e.g., by a user of the AR, VR, or MR headset).

In one embodiment of any of the above methods and systems, the headset comprises a processor, a memory, a transceiver, an image source, and an IMU.

In one embodiment of any of the above methods and systems, the display is an optical see-through display.

In one embodiment of any of the above methods and systems, the display is a video see-through display.

In one embodiment of any of the above methods and systems, the remote expert device further comprises at least one of gloves or a joystick.

A field technician using an augmented reality headset request remote assistance to remedy a problem. The augment reality headset connects to a server component which facilitates a connection to a remote expert wearing a virtual reality headset. Video is streamed from the field technician to the remote expert. The video shows a view of the field technician's environment and issue the technician is tasked to resolve. The remote expert can view the environment and the issue on the virtual reality headset. The remote expert can provide: audio instruction, video instruction (e.g. training video) and/or a demonstration of the instructions. The audio, video or virtual demonstration are streamed back to the field technician via the collaboration manager.

Embodiments described herein may be used to enable a field technician to receive a virtual demonstration from a remote expert on how to perform a function.

A field technician is on premise with a headset on. The headset can be an augmented reality headset that has at a minimum the following: a wired or wireless internet connection, a display, a camera, a microphone and speaker. The headset is capable of recording video and streaming it over the internet. The headset has a computer processor or is connected to a computer processor that is capable of running an application. The application connects the headset to a server (the collaboration manager). The collaboration manager allows the headset to request assistance and to record a session.

The wearer of the headset can request assistance in the form of audio instruction, video instruction, online documentation, and/or remote expert. When a remote expert is requested, the collaboration manager makes a connection to one or more remote expert.

The remote expert can be using a computer, a laptop, a phone or a headset that contains a process that can run an application. The headset at a minimum contains: a wired or wireless internet connection, a display, a camera, a microphone and speaker. The headset may or may not be capable of displaying virtual reality content. The headset may be used in conjunction with one or more input devices (for example, hand held controllers, pointers, or gloves) that capture hand gestures and movement of the user.

The See What I See feature allows the remote expert to see the environment and the circumstance the field technician is experiencing. This is achieved by capture video from the field technician's camera and streaming that video to the remote expert's display device via the collaboration manager.

The Do What I Do feature is a possible response to the see what I see feature in that a remote expert decides what steps are required to be performed and acts at those steps in a virtual environment. The remote expert performs the actions on a virtual replica or a video replica of the equipment. The remote expert's movements and hand gestures are captured and a virtual representation of those actions are sent to the field technician to be played on the field technician's display device. That is the field technician sees a virtual representation (for example two hands overlaid on the field technician's display). The actions performed by the remote expert are shown to the field technician in the same manner as performed by the remote expert.

An Augmented Reality (AR) headset with camera provides the ability to capture video and audio. It also plays audio and video.

A Virtual Reality (VR) headset with camera and/or input devices plays video captured from augmented reality headset. It captures input from input devices and sends input to server.

A Collaboration Manager provides access to remote experts. Facilitates exchange of data between users.

A software application running on an AR headset or peripheral processor communicates with the collaboration manager.

A software application running on a VR headset or peripheral processor communicates with the collaboration manager.

The display device is preferably selected from the group comprising a desktop computer, a laptop computer, a mobile phone, an AR headset, and a VR headset.

The remote expert device is preferably selected from the group comprising a desktop computer, a laptop computer, a mobile phone, an AR headset, and a VR headset.

In one embodiment, a first user (e.g. field technician) puts on a pair of Augmented Reality (AR) glasses. The AR glasses are running an MRO application that offers a feature to request remote assistance.

Next, the first user requests assistance. The application on the AR headset makes a connection to the collaboration manager, a server component. The collaboration manager authenticates the headset and waits for a request. The AR headset sends a remote assistance request to the collaboration manager.

Next, The collaboration manager makes a request for a remote expert. The collaboration manager makes a connection to either: (a) a call center where a staff of remote experts are on duty or (b) a direct connection to a remote expert who is on duty. The remote expert uses an application running on a computer, laptop, phone, AR headset, or Virtual Reality (VR) headset to respond to the collaboration manager. A data connection is established between the collaboration manager and the application.

Next, the collaboration manager requests the AR application to start video capture. The AR headset starts capturing video and streaming the video to the collaboration manager. The collaboration manager stores the video and streams the video to the remote expert. The video can be either a 360 degree video, a 180 degree video or any viewing perspective of the camera attached to the AR headset.

Next, the remote expert views the video capture via a display device. The collaboration manager sends the video over the data connection to the remote expert's application. The application displays the video on the display endpoint identified by the remote expert. The display device can be: a monitor, a laptop, a phone, an AR headset or a VR headset.

Next, the remote expert can provide guidance via audio, video or virtual assistance. The remote expert opts to provide “virtual” assistance. The remote expert uses input devices to capture the movements and gestures of the remote expert. The input device used by the remote expert can be: handheld device such as a joystick or controller that contains an accelerometer and gyroscope to capture the geometry of the movement of the device. The input device could also be a part of gloves worn by the remote expert that capture the movement and gesture of the remote expert.

The movement and gestures are captured as the remote expert is using the input devices to demonstrate the functions that need to be performed by the field technician. The input devices collect data from the input devices' gyroscope and accelerometer to capture the movement and gestures of the remote expert. The data is used to move hands depicting the remote expert's behavior on the display device used by the remote expert.

Two options: (1) a video capturing the remote expert's demonstration including the virtual hands performing the functions can be captured and sent to the field technician or (2) the movement data from the accelerometer and gyro can be sent to the rendering engine of the AR headset and the virtual hands performing the functions can be displayed on the AR headset.

Option 1: a video is captured of the remote expert's hand movement and gestures and that video is streamed to collaboration manager.

Option 2: the accelerometer and gyro data is continuously captured and “streamed” to the collaboration manager.

The collaboration manager sends the data to the application on the AR headset.

Option 1: the video is played on the AR headset.

Option 2: The application on the AR headset contains a renderer that can turn the geometry collected from the accelerometer and gyro on the remote experts input devices to recreate the hand movement and gestures using virtual hands displayed on the AR headset.

The field technician mimics the movements of the remote expert to perform the necessary functions.

### Second Set of Additional Embodiments

Currently service agents out in the field rely on prior knowledge, any resources they can locate via an internet connection, and voice calls into next level support. In some cases service agents may not be able to remedy the problem without further education and/or hands on assistance from an expert which results in longer resolution times.

By using the capabilities of virtual reality embodiments described herein can offer a solution that allows a service agent to receive remote assistance from an expert that can show the agent how to resolve the issue or perform the function in a VR environment on a virtual replica of the object being repaired or maintained.

Embodiments described herein may be used to enable a remote expert to assist a field technician with a resolution to a problem and/or on premise training. The remote expert can provide verbal instruction along with hand gestures to illustrate the procedure. The remote expert can oversee the field technician performance to ensure the problem has been remedied correctly. This eliminates the need for the remote expert to be called out to the location and reduces the length of time it takes to solve a problem.

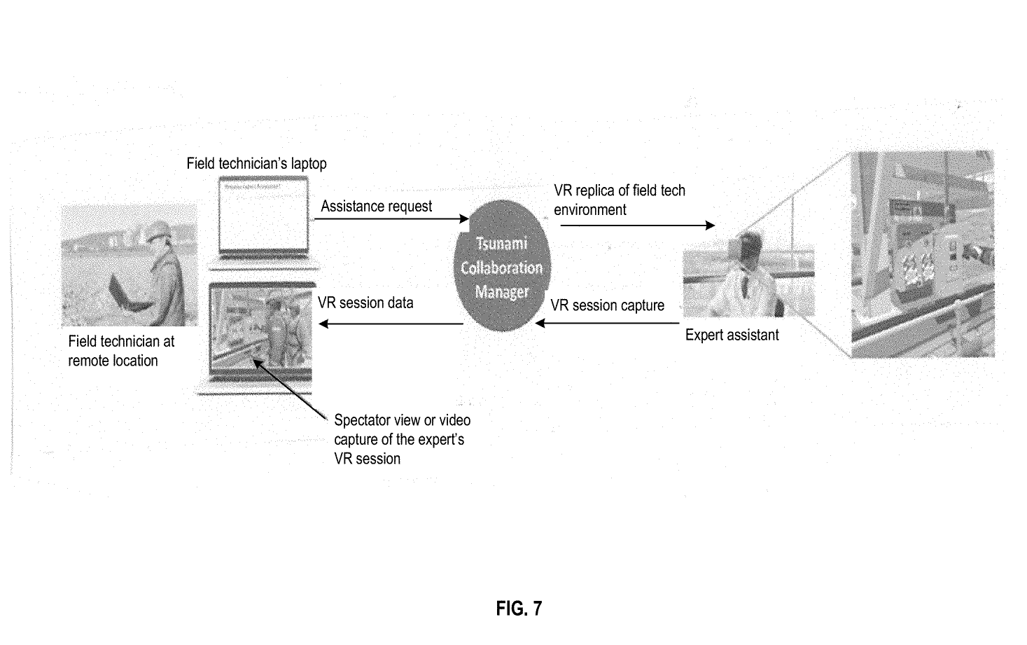

By way of example, FIG. 6 and FIG. 7 are block diagrams of methods for providing remote assistance.

One embodiment is a method for providing remote assistance via augmented reality (AR), virtual reality (VR) or mixed virtual and augmented reality (MR). The method includes receiving a remote assistance request at a collaboration manager on a server. The remote assistance request transmitted from an application of a display device at a remote location. The remote assistance request is to resolve a problem (e.g., an issue with an object). The method also includes transmitting a remote expert request from the collaboration manager to an application on a remote expert device located at a remote expert site. The method also includes transmitting an expert assistance content related to the request content from the application on the remote expert device to the application on the display device via the collaboration manager. The method also includes displaying the expert assistance content on the display device. The request content utilizes at least one of AR, VR or MR.

Another embodiment is a system for providing remote assistance via augmented reality (AR), virtual reality (VR) or mixed virtual and augmented reality (MR). The system comprises a collaboration manager at a server, a display device comprising an application, and a remote expert device comprising an application. The collaboration manager is configured to establish a connection between the collaboration manager and the application on the display device. The collaboration manager is configured to receive a remote assistance request from the display device at a remote location, the remote assistance request to resolve a problem. The collaboration manager is configured to transmit a remote expert request to the remote expert device. The collaboration manager is configured to receive request content from the display device and transmit the request content to the application on the remote expert device. The collaboration manager is configured to receive an expert assistance content from the application on the remote expert device and then transmit the expert assistance content to the application on the display device. The expert assistance content is displayed on the display device. The request content utilizes at least one of AR, VR or MR.

Embodiments described herein may use virtual reality and a collaboration engine to realize the solution. The field technician requests remote assistance via an application on a laptop or cell phone. The application sends a request to the collaboration manager. The collaboration manager submits a request to the call center for a “hands on” virtual expert. The collaboration manager provides the identification of the field technician and a description of equipment and the problem the field technician is attempting to solve in the request for help.

The call center puts a request to all available experts. A virtual expert in the call center answers the request. The virtual expert starts a VR session in an environment with a virtual replica of the equipment the field technician has identified. The virtual expert demonstrates on the virtual replica how to remedy the problem or perform the function identified by the field technician. The collaboration manager captures the VR session and the virtual expert's action and movement in the VR session. The capture of the VR session is sent to the field technician's application which plays it out in real time for the field technician. The field technician can then perform the same functions on the physical equipment.

Embodiments described herein may be used to enable a remote expert to assist a field technician with a resolution to a problem and/or on premise training using a recording of a VR session in which the remote expert is performing the function requested by the field technician. The remote expert can provide verbal instruction along with hand gestures to illustrate the procedure on the virtual replica of the equipment. This eliminates the need for the remote expert to be called out to the location and reduces the length of time it takes to resolve a problem or perform a maintenance function.

Embodiments described herein may be used to enable a field technician to receive a virtual demonstration from a remote expert on how to perform a function.

A field technician is on premise with a cell phone or laptop with internet access. The field technician device can receive and play a live video stream. The field technician's device is running an application that connects to a server (the collaboration manager). The application allows the field technician to request remote assistance. The collaboration manager provides interfaces to allow the application to submit a remote assistance request. The field technician can request assistance from a remote expert using VR. When a remote expert is requested, the collaboration manager makes a connection to a call center in which one or more remote experts are available. The call center has VR systems set up to allow the remote expert to be in a replica of the environment the field technician is also in. The VR headset contains or has access to: a wired or wireless internet connection, a display, a camera, a microphone and speaker. The VR headset may be used in conjunction with one or more input devices (for example, hand held controllers, pointers, or gloves) that capture hand gestures and movement of the user.

The remote expert uses the VR headset and input devices to perform the functions that the field technician needs to mimic in order to complete the field technician's assignment. The VR system connects to the collaboration manager which is connected to the field technician's application. As the remote expert performs the function, the VR system captures the remote expert's movements and sends the data to the collaboration manager. The collaboration manager determines whether to: (a) forward the captured data to the application on the field technician's device or (b) send a video capture of the VR session to the application on the field technician's device. The collaboration manager makes the determination by examining the type of device, connection and technology that is being used by the field technician. If the device is capable of participating in a VR session, the collaboration manager sends the VR session data to the field technician's device. The application on the device either plays back the VR session data or allows the field technician to join a collaboration session with the remote expert to see the actions performed by the remote expert in real time. If the device is not capable of participating in a VR session, then the application on the device can either play a video capture of the remote expert's VR session or allow the field technician to view the VR session in a observation only mode (i.e. 2-D mode). In any case, the field technician has enough instruction from the remote expert to perform the functions necessary to complete his/her task.

User 1 (e.g. field technician) goes into field to perform a function. The field technician is carrying a support device (e.g. mobile phone or laptop). The field technician's support device is running an MRO application that offers a feature to request remote assistance.

User 1 requests remote assistance. The application on the support device makes a connection to the collaboration manager, a server component. The collaboration manager authenticates the support device and waits for a request. The support device sends a remote assistance request to the collaboration manager.

The collaboration manager makes a request for a remote expert. The collaboration manager makes a connection to either: (a) a call center where a staff of remote experts are on duty or (b) a direct connection to a remote expert who is on duty. The remote expert uses an application running on a Virtual Reality (VR) headset to respond to the collaboration manager A data connection is established between the collaboration manager and the application.

The remote expert loads a VR environment that contains a virtual replica of the equipment. The VR system requests the collaboration manager to load a virtual environment that is a replica of the physical environment in which the field technician resides.

The VR assets are displayed on the VR system. The collaboration manager sends a requests to the content manager to retrieve the VR assets and environment. The collaboration manager sends the VR assets to the rendered to be displayed on the VR headset of the remote expert.

The remote expert uses audio and the VR input devices to perform the function requested. The VR input device used by the remote expert can be: handheld device such as a joystick or controller that contains an accelerometer and gyroscope to capture the geometry of the movement of the device. The input device could also be a part of gloves worn by the remote expert that capture the movement and gesture of the remote expert.

The movement and gestures are captured as the remote expert is using the input devices to demonstrate the functions that need to be performed by the field technician. The input devices collect data from the input devices' gyroscope and accelerometer to capture the movement and gestures of the remote expert. The data is used to move hands depicting the remote expert's behavior on the display device used by the remote expert. The audio is also captured and streamed to the field technician's application via the collaboration manager.

The field technician's application plays a spectator view of the remote expert's VR session. This can be seen via video stream of the session, screen sharing or participation in a collaborative VR session. The movement data from the remote expert's VR system is captured and sent to the collaboration manager. The collaboration manager sends the VR environment data and the movement data to the rendering engine of the application on the field technician's support device.

The field technician hears the remote expert's audio. The application on the support device plays the audio stream.

The field technician mimics the movements of the remote expert to perform the necessary functions.

The display device is preferably a head mounted display.

The client device is preferably a personal computer, laptop computer, tablet computer or mobile computing device such as a smartphone.

The display device is preferably selected from the group comprising a desktop computer, a laptop computer, a tablet computer, a mobile phone, an AR headset, and a virtual reality (VR) headset.

The user interface elements include the capacity viewer and mode changer.

By way of example, a first t method for providing remote assistance via augmented reality (AR), virtual reality (VR) or mixed virtual and augmented reality (MR) comprises: receiving a remote assistance request at a collaboration manager on a server, the remote assistance request transmitted from an application of a client device at a remote location, the remote assistance request to resolve an issue with an object; transmitting an expert request from the collaboration manager to an application on an expert device located at an expert site; preparing a virtual environment that contains a virtual replica of the object to be resolved with a plurality of virtual assets; performing as a virtual session a function in the virtual environment to resolve the issue with the object; recording as an expert assistance content the movement and gestures of the expert in the virtual environment that are performed for the function to resolve the issue with the object; determining at the collaboration manager to forward the expert assistance content or a video of the virtual session based on the type of client device, a connection bandwidth and a technology utilized at the remote location; transmitting the expert assistance content or video of the virtual session to the client device from the collaboration manager; and performing the functions to resolve the issue with the object.

In one embodiment of the first method, the collaboration manager determines to transmit a video of the virtual session to the client device, and the client device plays the video to assist in resolving the issue with the object.

In one embodiment of the first method, the collaboration manager determines to transmit the expert assistance content and the client device loads the expert assistance content to assist in resolving the issue with the object.

In one embodiment of the first method, a technician participates in a collaboration virtual session with the expert to resolve the issue with the object.

In one embodiment of the first method, a HMD is structured to hold the client device, and the client device comprises a processor, a camera, a memory, a software application residing in the memory, an IMU, and a display screen.

In one embodiment of the first method, the client device is a head mounted display (“HMD”) comprising a processor, an IMU, and a display screen.

In one embodiment of the first method, the client device is selected from the group comprising a desktop computer, a laptop computer, a mobile phone, an AR headset, VR headset and a MR headset.

In one embodiment of the first method, the expert assistance content utilizes at least one of AR, VR or MR.

In one embodiment of the first method, the problem is at least one of an equipment repair, a medical emergency, a maintenance operation, troubleshooting equipment, or performing a medical procedure.

In different embodiments of the first method, the display device is an AR headset and the expert device is an AR headset, the display device is an AR headset and the expert device is a VR headset, the display device is a VR headset and the expert device is a VR headset, or the display device is a VR headset and the expert device is an AR headset.

In one embodiment of the first method, the request content utilizes AR and the expert assistance content utilizes AR, the request content utilizes VR and the expert assistance content utilizes VR, the request content utilizes MR and the expert assistance content utilizes MR, the request content utilizes AR and the expert assistance content utilizes VR, the request content utilizes AR and the expert assistance content utilizes MR, the request content utilizes VR and the expert assistance content utilizes AR, the request content utilizes VR and the expert assistance content utilizes MR, the request content utilizes MR and the expert assistance content utilizes AR, or the request content utilizes MR and the expert assistance content utilizes VR.

In one embodiment of the first method, the expert assistance content is an audio content, a video content, an overlay of hands, an overlay of other instructional content, or any combination thereof, wherein the expert assistance content shows a person how to do perform a function.

In one embodiment of the first method, the expert device is selected from the group comprising a desktop computer, a laptop computer, a mobile phone, an AR headset, a VR headset, and a MR headset.

In one embodiment of the first method, the expert device comprises a plurality of sensors to capture human action for the expert assistance content.

In one embodiment of the first method, the method further comprises rendering the expert assistance content on the application of the display device into one of a plurality of movements performed by virtual hands displayed on the display device, a virtual pointer with a plurality of circles, audio instructions or text instructions.

In one embodiment of the first method, the display device is an AR headset, VR headset or MR headset comprising a video camera, a display, a processor, a memory, a transceiver, an image source, and an IMU.

By way of example, a second method for providing remote assistance comprises: receiving a remote assistance request at a collaboration manager on a server, the remote assistance request transmitted from a client device (e.g., VR or AR headset) at a remote location, the remote assistance request to resolve a problem, the client device comprising a video camera and a VR or AR display; transmitting an expert request from the collaboration manager to an application on an expert device located at an expert site; preparing a virtual environment that contains a virtual replica of the object to be resolved with a plurality of virtual assets; performing as a virtual session a function in the virtual environment to resolve the issue with the object; recording as an expert assistance content the movement and gestures of the expert in the virtual environment that are performed for the function to resolve the issue with the object; determining at the collaboration manager to forward the expert assistance content or a video of the virtual session based on the type of client device, a connection bandwidth and a technology utilized at the remote location; transmitting the expert assistance content or video of the virtual session to the client device from the collaboration manager; and performing the functions to resolve the issue with the object.

In one embodiment of the second method, a HMD is structured to hold the client device, and the client device comprises a processor, a camera, a memory, a software application residing in the memory, an IMU, and a display screen.

In one embodiment of the second method, the client device is a head mounted display (“HMD”) comprising a processor, an IMU, and a display screen.

In one embodiment of the second method, the client device is selected from the group comprising a desktop computer, a laptop computer, a mobile phone, an AR headset, VR headset and a MR headset.

In one embodiment of the second method, the expert assistance content is a plurality of movements and gestures to resolve the problem captured using at least one of an accelerometer or gyroscope of the expert device.

In one embodiment of the second method, the expert device is selected from the group comprising a desktop computer, a laptop computer, a mobile phone, an augmented reality headset, and a second VR headset.

In one embodiment of the second method, the video is a 360 degree video, a 180 degree video, a range of view video, or a field of view video.

By way of example, a third method for providing remote assistance comprises:

establishing a connection between an application on an augmented reality (AR) headset and a collaboration manager on a server, the AR headset comprising a video camera and an AR display; authenticating the AR headset; transmitting a remote assistance request from the application on the AR headset to the collaboration manager, the remote assistance request to resolve a problem, the remote assistance request for an expert device; receiving a request from the collaboration manager at the AR headset to capture video using the video camera of the AR headset; preparing a virtual environment that contains a virtual replica of the object to be resolved with a plurality of virtual assets;

performing as a virtual session a function in the virtual environment to resolve the issue with the object; recording as an expert assistance content the movement and gestures of the expert in the virtual environment that are performed for the function to resolve the issue with the object; determining at the collaboration manager to forward the expert assistance content or a video of the virtual session based on the type of client device, a connection bandwidth and a technology utilized at the remote location; transmitting the expert assistance content or video of the virtual session to the client device from the collaboration manager; and performing the functions to resolve the issue with the object.

In one embodiment of the third method, the expert assistance content is a plurality of movements and gestures to resolve the problem captured using at least one of an accelerometer or gyroscope of the expert device.

In one embodiment of the third method, the expert device is selected from the group comprising a desktop computer, a laptop computer, a mobile phone, a second AR headset, and a virtual reality (VR) headset.

In one embodiment of the third method, the video is a 360 degree video, a 180 degree video, a range of view video, or a field of view video.

In one embodiment of the third method, the method further comprises rendering the expert assistance content on the application of the AR headset into a plurality of movements performed by virtual hands displayed on the AR display of the AR headset.

In one embodiment of the third method, the AR headset further comprises a processor, a memory, a transceiver, an image source, and an IMU.

In one embodiment of the third method, the AR display is an optical see-through display.

In one embodiment of the third method, the AR display is a video see-through display.

By way of example, a fourth method for providing remote assistance comprises: establishing a connection between an application on a VR headset and a collaboration manager on a server, the VR headset comprising a video camera and an AR display; authenticating the AR headset; transmitting a remote assistance request from the application on the VR headset to the collaboration manager, the remote assistance request to resolve a problem, the remote assistance request for an expert device;

receiving a request from the collaboration manager at the VR headset to capture video using the video camera of the AR headset; loading a virtual environment that contains a virtual replica of the object to be resolved; performing a function in the virtual environment comprising a plurality of virtual assets to resolve the issue with the object; capturing as an expert assistance content the movement and gestures of the expert in the virtual environment that are performed for the function to resolve the issue with the object; transmitting the expert assistance content to the client device via the collaboration manager; and displaying the expert assistance content on the client device; and performing the functions to resolve the issue with the object.

In one embodiment of the fourth method, the expert assistance content is a plurality of movements and gestures to resolve the problem captured using at least one of an accelerometer or gyroscope of the expert device.

In one embodiment of the fourth method, the expert device is selected from the group comprising a desktop computer, a laptop computer, a mobile phone, a augmented reality headset, and a second VR headset.

In one embodiment of the fourth method, the video is a 360 degree video, a 180 degree video, a range of view video, or a field of view video.

In one embodiment of the fourth method, the method further comprises rendering the expert assistance content on the application of the VR headset into a plurality of movements performed by virtual hands displayed on the VR display of the VR headset.

In one embodiment of the fourth method, the VR headset further comprises a processor, a memory, a transceiver, an image source, and an IMU.

By way of example, a fifth method for providing remote assistance comprises: establishing a connection between a collaboration manager on a server and an application on an augmented reality (AR) headset; receiving a remote assistance request at the collaboration manager, the remote assistance request transmitted from the AR headset at a remote location, the remote assistance request to resolve a problem, the AR headset comprising a video camera and an AR display; transmitting an expert request from the collaboration manager to an expert device located at an expert site; establishing a connection between the collaboration manager and an application on remote expert device; transmitting a request from the collaboration manager to the AR headset to capture video using the video camera of the AR headset; preparing a virtual environment that contains a virtual replica of the object to be resolved with a plurality of virtual assets; performing as a virtual session a function in the virtual environment to resolve the issue with the object; recording as an expert assistance content the movement and gestures of the remote expert in the virtual environment that are performed for the function to resolve the issue with the object; determining at the collaboration manager to forward the expert assistance content or a video of the virtual session based on the type of client device, a connection bandwidth and a technology utilized at the remote location; transmitting the expert assistance content or video of the virtual session to the client device from the collaboration manager; and performing the functions to resolve the issue with the object.

In one embodiment of the fifth method, the expert assistance content is a plurality of movements and gestures to resolve the problem captured using at least one of an accelerometer or gyroscope of the expert device.

In one embodiment of the fifth method, the expert device is selected from the group comprising a desktop computer, a laptop computer, a mobile phone, a second AR headset, and a virtual reality (VR) headset.

In one embodiment of the fifth method, the video is a 360 degree video, a 180 degree video, a range of view video, or a field of view video.

In one embodiment of the fifth method, comprising displaying the video on a display endpoint of the remote expert device.

In one embodiment of the fifth method, the method further comprises rendering the expert assistance content on the application of the AR headset into a plurality of movements performed by virtual hands displayed on the AR display of the AR headset.

In one embodiment of the fifth method, the AR headset further comprises a processor, a memory, a transceiver, an image source, and an IMU.

In one embodiment of the fifth method, the AR display is an optical see-through display or a video see-through display.

In one embodiment of the fifth method, the method further comprises authenticating the AR headset at the collaboration manager.

By way of example, a sixth method for providing remote assistance comprises:

establishing a connection between a collaboration manager on a server and an application on a virtual reality (VR) headset; authenticating the VR headset at the collaboration manager; receiving a remote assistance request at the collaboration manager, the remote assistance request transmitted from the VR headset at a remote location, the remote assistance request to resolve a problem, the VR headset comprising a video camera and a VR display; transmitting an expert request from the collaboration manager to an expert device located at an expert site; establishing a connection between the collaboration manager and an application on expert device; transmitting a request from the collaboration manager to the VR headset to capture video using the video camera of the VR headset; preparing a virtual environment that contains a virtual replica of the object to be resolved with a plurality of virtual assets; performing as a virtual session a function in the virtual environment to resolve the issue with the object; recording as an expert assistance content the movement and gestures of the remote expert in the virtual environment that are performed for the function to resolve the issue with the object; determining at the collaboration manager to forward the expert assistance content or a video of the virtual session based on the type of client device, a connection bandwidth and a technology utilized at the remote location; transmitting the expert assistance content or video of the virtual session to the client device from the collaboration manager; and performing the functions to resolve the issue with the object.

In one embodiment of the sixth method, the expert assistance content is a plurality of movements and gestures to resolve the problem captured using at least one of an accelerometer or gyroscope of the remote expert device.

In one embodiment of the sixth method, the expert device is selected from the group comprising a desktop computer, a laptop computer, a mobile phone, a augmented reality headset, and a second VR headset.

In one embodiment of the sixth method, the video is a 360 degree video, a 180 degree video, a range of view video, or a field of view video.

In one embodiment of the sixth method, the method further comprises displaying the video on a display endpoint of the remote expert device.

In one embodiment of the sixth method, the method further comprises rendering the expert assistance content on the application of the VR headset into a plurality of movements performed by virtual hands displayed on the VR display of the VR headset.

In one embodiment of the sixth method, the VR headset further comprises a processor, a memory, a transceiver, an image source, and an IMU.

By way of example, a first system for providing remote assistance via augmented reality (AR), virtual reality (VR) or mixed virtual and augmented reality (MR) comprises: a collaboration manager at a server; a display device comprising an application;

an expert device comprising an application; wherein the collaboration manager is configured to establish a connection between the collaboration manager and the application on the display device; wherein the collaboration manager is configured to receive a remote assistance request from the display device at a remote location, the remote assistance request to resolve a problem; wherein the collaboration manager is configured to transmit an expert request to the expert device; wherein the collaboration manager is configured to receive request content from the display device and transmit the request content to the application on the expert device; wherein the collaboration manager is configured to prepare a virtual environment that contains a virtual replica of the object to be resolved with a plurality of virtual assets; wherein the collaboration manager is configured to perform as a virtual session a function in the virtual environment to resolve the issue with the object; wherein the collaboration manager is configured to record as an expert assistance content the movement and gestures of the expert in the virtual environment that are performed for the function to resolve the issue with the object; wherein the collaboration manager is configured to determine at the collaboration manager to forward the expert assistance content or a video of the virtual session based on the type of client device, a connection bandwidth and a technology utilized at the remote location; wherein the collaboration manager is configured to transmit the expert assistance content or video of the virtual session to the display device from the collaboration manager; wherein the display device is configured to perform the functions to resolve the issue with the object; and wherein the request content utilizes at least one of AR, VR or MR.

In one embodiment of the first system, the collaboration manager determines to transmit a video of the virtual session to the client device, and the client device plays the video to assist in resolving the issue with the object.

In one embodiment of the first system, the collaboration manager determines to transmit the expert assistance content and the client device loads the expert assistance content to assist in resolving the issue with the object.

In one embodiment of the first system, a technician participates in a collaboration virtual session with the remote expert to resolve the issue with the object.

In one embodiment of the first system, the display device is an AR headset and the expert device is a VR headset.

In one embodiment of the first system, the display device is a VR headset and the expert device is a VR headset.

In one embodiment of the first system, the display device is a VR headset and the expert device is an AR headset.

In one embodiment of the first system, the expert assistance content is an audio content, a video content, an overlay of hands, an overlay of other instructional content, or any combination thereof, wherein the expert assistance content shows a person how to do perform a function.

In one embodiment of the first system, the expert device is selected from the group comprising a desktop computer, a laptop computer, a mobile phone, an AR headset, and a VR headset.

In one embodiment of the first system, the display device is selected from the group comprising a desktop computer, a laptop computer, a mobile phone, an AR headset, and a VR headset.

In one embodiment of the first system, the expert device comprises a plurality of sensors to capture human action for the expert assistance content.

In one embodiment of the first system, the display device is configured to render the expert assistance content on the application of the display device into one of a plurality of movements performed by virtual hands displayed on the display device, a virtual pointer with a plurality of circles, audio instructions or text instructions.

In one embodiment of the first system, a HMD is structured to hold the display device, and the display device comprises a processor, a camera, a memory, a software application residing in the memory, an IMU, and a display screen.

In one embodiment of the first system, the display device is a head mounted display (“HMD”) comprising a processor, an IMU, and a display screen.

In one embodiment of the first system, the display device is selected from the group comprising a desktop computer, a laptop computer, a mobile phone, an AR headset, VR headset and a MR headset.

In one embodiment of the first system, the display device is an AR headset, VR headset or MR headset comprising a video camera, a display, a processor, a memory, a transceiver, an image source, and an IMU.

In one embodiment of the first system, the expert assistance content utilizes at least one of AR, VR or MR.

In one embodiment of the first system, the display device is an AR headset and the expert device is an AR headset.

By way of example, a second system for providing remote assistance comprises: a collaboration manager at a server; an virtual reality (VR) headset comprising an application, a video camera and a VR display; an expert device comprising an application; wherein a connection is established between the collaboration manager and the application on the VR headset, and the VR headset is authenticated; wherein a remote assistance request is transmitted from the VR headset at a remote location to the collaboration manager, the remote assistance request to resolve a problem; wherein an expert request is transmitted from the collaboration manager to the expert device; wherein the collaboration manager is configured to prepare a virtual environment that contains a virtual replica of the object to be resolved with a plurality of virtual assets; wherein the collaboration manager is configured to perform as a virtual session a function in the virtual environment to resolve the issue with the object; wherein the collaboration manager is configured to record as an expert assistance content the movement and gestures of the expert in the virtual environment that are performed for the function to resolve the issue with the object; wherein the collaboration manager is configured to determine at the collaboration manager to forward the expert assistance content or a video of the virtual session based on the type of client device, a connection bandwidth and a technology utilized at the remote location; wherein the collaboration manager is configured to transmit the expert assistance content or video of the virtual session to the client device from the collaboration manager; and wherein the VR headset is configured to perform the functions to resolve the issue with the object.

In one embodiment of the second system, the expert assistance content is a plurality of movements and gestures to resolve the problem captured using at least one of an accelerometer or gyroscope of the remote expert device.

In one embodiment of the second system, the expert device is selected from the group comprising a desktop computer, a laptop computer, a mobile phone, a second AR headset, and a virtual reality (VR) headset.

In one embodiment of the second system, the video is a 360 degree video, a 180 degree video, a range of view video, or a field of view video.

By way of example, a third system for providing remote assistance via augmented reality (AR) comprises: a collaboration manager at a server; an AR headset comprising an application, a video camera and an AR display; an expert device comprising an application; wherein a connection is established between the collaboration manager and the application on the AR headset, and the AR headset is authenticated; wherein a remote assistance request is transmitted from the AR headset at a remote location to the collaboration manager, the remote assistance request to resolve a problem; wherein the expert request is transmitted from the collaboration manager to the expert device; wherein the collaboration manager is configured to prepare a virtual environment that contains a virtual replica of the object to be resolved with a plurality of virtual assets; wherein the collaboration manager is configured to perform as a virtual session a function in the virtual environment to resolve the issue with the object; wherein the collaboration manager is configured to record as an expert assistance content the movement and gestures of the remote expert in the virtual environment that are performed for the function to resolve the issue with the object; wherein the collaboration manager is configured to determine at the collaboration manager to forward the expert assistance content or a video of the virtual session based on the type of client device, a connection bandwidth and a technology utilized at the remote location; wherein the collaboration manager is configured to transmit the expert assistance content or video of the virtual session to the client device from the collaboration manager; and wherein the AR headset is configured to perform the functions to resolve the issue with the object.

In one embodiment of the third system, the expert assistance content is a plurality of movements and gestures to resolve the problem captured using at least one of an accelerometer or gyroscope of the remote expert device.

In one embodiment of the third system, the expert device is selected from the group comprising a desktop computer, a laptop computer, a mobile phone, a second AR headset, and a virtual reality (VR) headset.

In one embodiment of the third system, the video is a 360 degree video, a 180 degree video, a range of view video, or a field of view video.

In one embodiment of the third system, the video is displayed on a display endpoint of the expert device.

In one embodiment of the third system, the expert assistance content is rendered on the application of the AR headset into a plurality of movements performed by virtual hands displayed on the AR display of the AR headset.

In one embodiment of the third system, the AR headset further comprises a processor, a memory, a transceiver, an image source, and an IMU.

In one embodiment of the third system, the AR display is an optical see-through display.

In one embodiment of the third system, the AR display is a video see-through display.

In one embodiment of the third system, the remote expert device further comprises at least one of gloves or a joystick.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need >10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a VR meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to.

View all active (registered) meeting participants

View all meeting participant's display devices

View the content the meeting participant is viewing

View metrics (e.g. dwell time) on the participant's viewing of the content

Change the content on the participant's device

Enable and disable the participant's ability to fast forward or rewind the content

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets. communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages.

Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies. By way of example, a virtual environment in AR may include one or more digital layers that are superimposed onto a physical (real world environment).

The user of a user device may be a human user, a machine user (e.g., a computer configured by a software program to interact with the user device), or any suitable combination thereof (e.g., a human assisted by a machine, or a machine supervised by a human).

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for providing expert assistance from a remote expert to a user operating an augmented reality device, the method comprising:
receiving, at a server, a remote assistance request from a first user device operated by a first user located at a first location;
after receiving the remote assistance request, establishing a network connection between the first user device and a second user device operated by a second user located at a second location;
receiving visual information captured by a camera of the first user device operated by the first user, wherein the visual information includes an image of a physical object in view of the first user;
transmitting the visual information to the second user device operated by the second user;
receiving, from the second user device operated by the second user, assistance content generated by the second user using the second user device; and
transmitting the assistance content to the first user device for presentation of the assistance content to the first user.

2. The method of claim 1, wherein the first user device is a head-mounted augmented reality user device with a display that is at least partially transparent.

3. The method of claim 1, wherein the second user device is a head-mounted augmented reality user device with a display that is at least partially transparent, or a head-mounted virtual reality device, stationary computer, or mobile computer with a non-transparent display.

4. The method of claim 1, wherein the first user device is a head-mounted augmented reality user device with a display that is at least partially transparent, and wherein the second user device is a head-mounted augmented reality user device with a display that is at least partially transparent.

5. The method of claim 1, wherein the method further comprises: presenting the visual information on a display of the second user device.

6. The method of claim 5, wherein the presented visual information includes the image of the physical object that is in view of the first user, wherein the assistance content is generated for display at one or more positions relative to particular parts of the physical object, and wherein the method comprises: presenting the assistance content on a display of the first user device to appear at the one or more positions relative to the particular parts of the physical object.

7. The method of claim 1, wherein the method comprises: presenting the assistance content at predefined locations of a display of the first user device.

8. The method of claim 1, wherein the assistance content includes visual content or audio content generated by the second user.

9. The method of claim 8, wherein the assistance content includes instructions the first user must follow to complete a task in relation to the physical object.

10. The method of claim 8, wherein the assistance content includes visual content generated by the second user, and wherein the method further comprises: presenting the visual content on a display of the first user device.

11. The method of claim 8, wherein the assistance content includes audio content, and wherein the method further comprises: presenting the audio content using a speaker of the first user device.

12. The method of claim 1, wherein the assistance content generated by the second user includes one or more movements or gestures the first user must make to complete a task in relation to the physical object in view of the first user, and wherein the method further comprises: presenting a visual representation of the one or more movements or gestures on a display of the first user device.

13. The method of claim 12, wherein the one or more movements or gestures generated by the second user are captured using a camera of the second user device.

14. The method of claim 12, wherein visual representations of the one or more movements or gestures are presented on a display of the first user device as virtual hands that perform the movements and gestures.

15. The method of claim 12, wherein the one or more movements or gestures are captured using an inertial sensor of the second user device or a peripheral device that is connect to the second user device and controlled by the second user.

16. The method of claim 1, wherein the method further comprises:
identifying the physical object;
selecting assistance information about the identified physical object; and
transmitting the assistance information to the first user device for presentation of the assistance information to the first user.

17. The method of claim 1, wherein the first location and the second location are different.

18. The method of claim 1, (i) wherein transmitting the visual information to the second user device operated by the second user includes generating a virtual environment that contains a virtual replica of the physical object, and transmitting the virtual environment and the virtual replica to the second user device, and (ii) wherein receiving assistance content generated by the second user using the second user device includes recording, as the assistance content, movement and gestures made by the second user in the virtual environment, wherein the movement and gestures are performed relative to the virtual replica to shown how to resolve an issue with the physical object.

19. A system for providing expert assistance from a remote expert to a user operating an augmented reality device, wherein the system comprises one or more machines and one or more non-transitory machine-readable media storing instructions that are operable, when executed by the one or more machines, to cause the one or more machines to perform operations of the method of claim 1.

20. One or more non-transitory machine-readable media embodying program instructions that, when executed by one or more machines, cause the one or more machines to implement the method of claim 1.
